(19) United States
(12) Patent Application Publication
(10) Pub. No.: US 2017/0251329 A1
(43) Pub. Date: Aug. 31, 2017

(54) IDENTIFICATION AND DISCOVERY OF EXPOSED SERVICES IN A DIGITAL COMMUNICATION NETWORK

(71) Applicant: ZTE Corporation, Shenzhen (CN)

(72) Inventor: Rajesh Bhalla, Gahanna, OH (US)

(21) Appl. No.: 15/514,457

(22) PCT Filed: Sep. 24, 2015
(86) PCT No.: PCT/CN2015/090530

§ 371 Date: Mar. 24, 2017

Related U.S. Application Data
(60) Provisional application No. 62/054,943, filed on Sep. 24, 2014.

(51) Int. Cl. H04W 4/00; H04W 48/16

(52) U.S. Cl. CPC H04W 4/005; H04W 48/16

(57) ABSTRACT

In a machine to machine (M2M) communication system, a service exposure function provides interfaces to an application server and an entity in a network in order to make available resource information from the network to the application server to facilitate M2M communication between an application executed on the application server and a communication device operating in the network.

### CROSS REFERENCE TO RELATED APPLICATIONS

This patent application claims the benefit of U.S. Provisional Patent Application No. 62/054,943, filed Sep. 24, 2014. The entire content of the before-mentioned patent application is incorporated by reference as part of the disclosure of this application.

### BACKGROUND

This document relates to machine-to-machine (M2M) communication.

M2M communication generally refers to communication between two different devices, which is not explicitly triggered by a user. Devices may perform M2M communication using wired or wireless connectivity. The communication is typically initiated by an application residing on one of the machine to gather or send information to a counterpart application on the other machine.

### SUMMARY

This document describes technologies, among other things, for enabling deployment of machine to machine application over communication networks that differ from each other in a variety of ways such as the frequency band and communication protocols.

In one aspect, methods, systems and apparatus for facilitating Machine-to-Machine (M2M) communication are disclosed. The method includes providing a service capability exposure function (SCEF) in a communication network for storing and providing service capability information, configuring a first programmer interface of the SCEF by which the SCEF exchanges messages with a network entity in the communication network and receives information about resources available in the communication network, configuring a second programmer interface to the SCEF by which the SCEF exchanges messages with an application to provide the application with information about the resources and to receive resource requests from the application, and facilitating an M2M communication service between a communication device operating in the communication network and an application server hosting the application.

These and other aspects, and their implementations and variations are set forth in the drawings, the description and the claims.

### BRIEF DESCRIPTION OF THE DRAWINGS

FIG. 1 depicts example wireless network architecture.

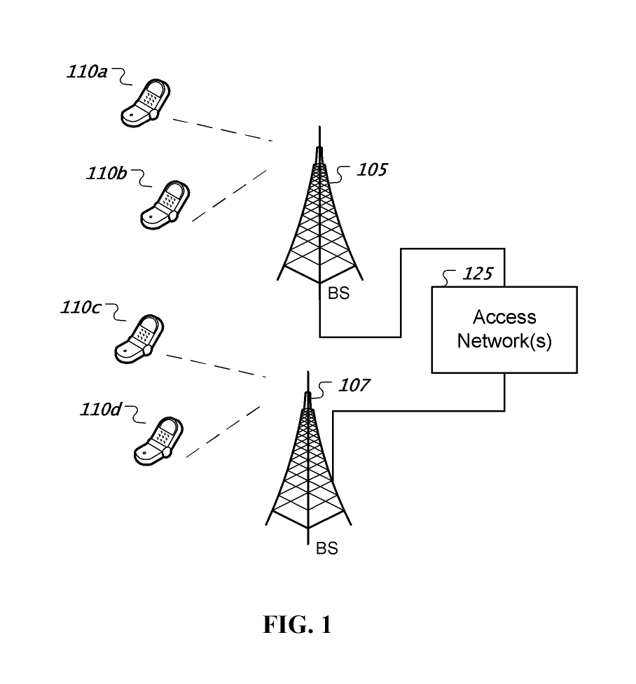

FIG. 2 is a block diagram of a radio device operable in a wireless network.

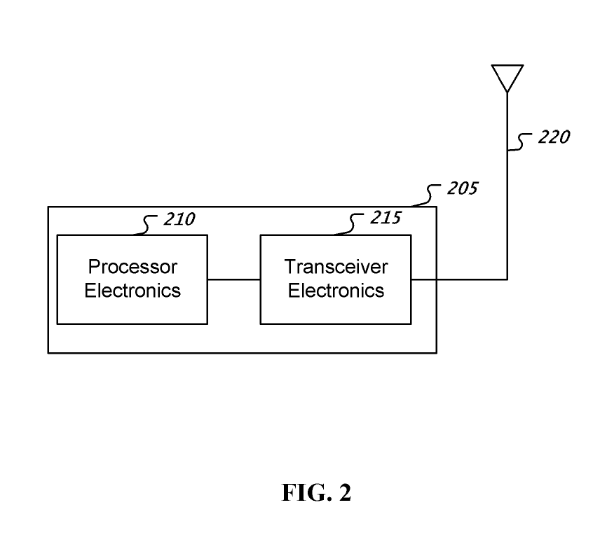

FIG. 3 shows a block diagram of an example network architecture.

FIG. 4 shows a block diagram of an example of a service capability exposure framework.

FIG. 5 shows an example of a method of facilitating M2M communication.

FIG. 6 shows an example block diagram of an apparatus for facilitating M2M communication.

FIG. 7 shows another example of a method of facilitating M2M communication.

Like reference symbols in the various drawings indicate like elements.

### DETAILED DESCRIPTION

In Machine to Machine (M2M) communications, the two endpoints between which communication occurs often are in different networks. For example, one device may be in a cellular network, e.g., a 3GPP or Long Term Evolution (LTE) network, or a wireless local area (WLAN) network such as 802.11, while the other device may be in the Internet cloud. In a typical application scenario, one endpoint may be a sensor or a utility box that may go offline for extended time periods and another endpoint may be an application server such as a utility billing server or an M2M server that may be deployed in a managed network.

When M2M devices sleep for long durations and awaken intermittently, these devices may be operating and communicating in a network that looks, resource-wise, different from the last time the M2M device was awake. Resources may include physical layer bandwidth, application level support, power control, etc.

The success of M2M services, e.g., efforts to write (e.g., software coding), develop, deploy and operate M2M services should not depend on such operational variability in M2M communication. Changes to available resources at run time may be even more critical for M2M communication especially because M2M devices may not be accessible via a user interface for changing their settings or downloading new apps to the user device to keep up with changes to the operational conditions.

Techniques described in this documents can be used to overcome these problems, and others. As examples, embodiments in oneM2M and 3GPP network settings are discussed. The disclosed techniques, in one aspect, make service information available to devices using a standardized application programming interface (API), and establishing a framework by which service information is exposed to M2M devices, without the M2M devices having to spend valuable wakeup time to search for services in the network. In one advantageous aspect, in some embodiments, the framework communicates with the home subscriber server (HSS), which contains user-related and subscriber-related information, information about managing device mobility, user authentication, and so on.

The present document discloses a service capability exposure framework in the Architecture Enhancements for Service Capability Exposure (AESE) architecture to provide the capability for the identification and definition of service capabilities of devices operating in a particular network, e.g., a 3GPP system, exposed to the external entities, such as application servers, and for the external entities to have the capability to discover such set of exposed service capabilities.

AESE Service Capability Exposure Architecture supports the exposure of 3GPP (3rd generation partnership project) system capabilities to external Applications/SCS entities via one or more standardized APIs. The Service Capability Exposure Architecture includes the APIs developed by other organizations, such as Open Mobile Alliance, OMA, Global System for Mobile Association, GSMA, others . . . ) and network interfaces and network entities specified by, e.g., 3GPP.

The Service Capability Exposure Architecture allows the 3GPP Mobile Network Operators (MNOs) to expose a set of service capabilities to Application/SCS (Services Capabilities Server) entities. In addition, the MNOs can expose a different set of service capabilities depending on their network capabilities and/or based on business relationships. It would be, therefore, advantageous that Applications/SCS entities to determine the service capabilities exposed by different underlying 3GPP networks while accessing services by the use of APIs. Stated differently, the Applications/SCS entities should be able to access services from different underlying 3GPP networks which may have exposed a different set of service capabilities via the AESE (Architecture Elements for Services Exposure) specified Service Capability Exposure Function.

The Infrastructure Node (IN) in the one M2M architecture which is mapped to the SCS can communicate with a multitude of ASNs/MNs (devices/gateways). Such ASNs/MNs could be reachable via different Underlying Networks. Some such Underlying Networks can be 3GPP MNOs. The Underlying Network via which an ASN/MN can be reached can change due to the mobility of such device/gateways. This is especially useful in M2M applications, where devices may sleep and awaken with significant time having elapsed (days or months) and may wake up in an entirely different location. It should, therefore, be possible for the SCS (IN) to determine the set of service capabilities that have been exposed by the underlying 3GPP network before initiating communication with a 3GPP capable device/gateway (ASN/MN).

With this in mind, for the Service Capability Exposure Architecture being defined for AESE (TR23.708 of 3GPP), it should be possible for the 3GPP MNO to identify and define, to the Service Capability Exposure Function, the set of service capabilities that have been exposed, e.g., made available for discover y and usage by other entities, and for the Application entities to be able to discover from the Service Capability Exposure Function the set of such exposed service capabilities, hence the set of associated APIs that can be used while accessing services via such 3GPP MNO.

In some embodiments, a Service capability exposure function (SCEF) may be provided in the network. The SCEF may have the capability for the identification and definition of the 3GPP system service capabilities exposed to the external entities, and for the external entities the capability to discover such set of exposed service capabilities.

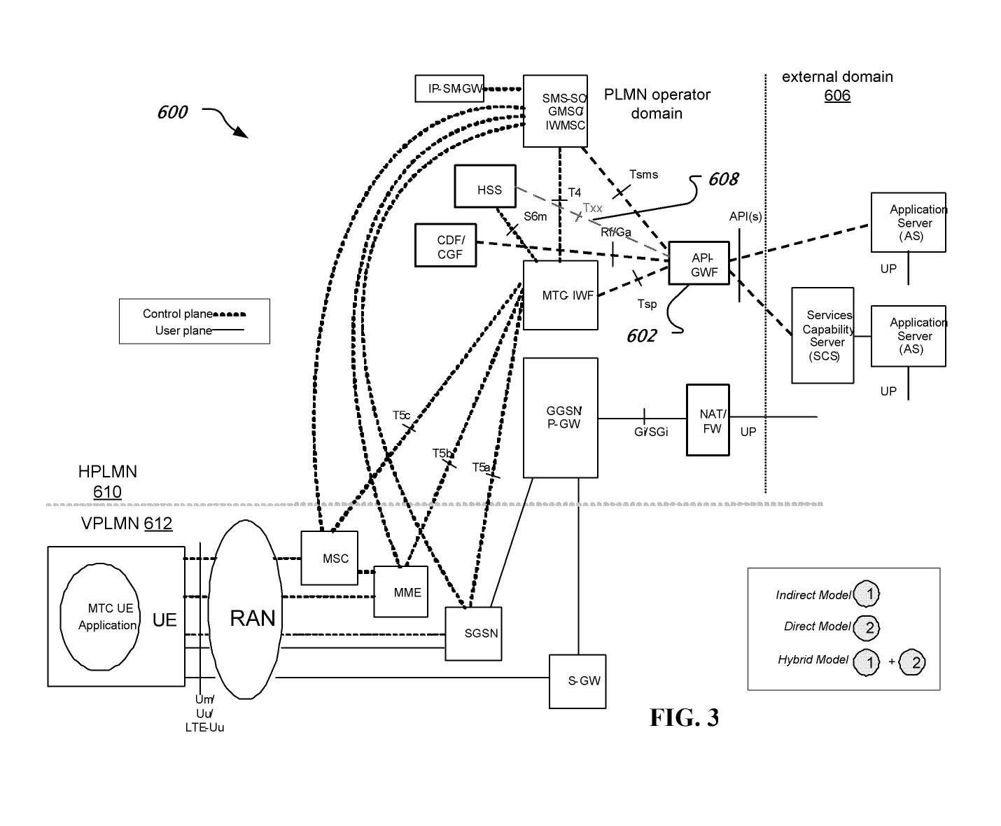

FIG. 3 is a block diagram illustrating an example of architecture 600 for device triggering applying an API-GWF (gateway function) 602. In FIG. 3, a home public land mobile network (HPLMN) 610 and a visited land mobile network (VPLMN) 612 are shown operating, hosting M2M devices and interfacing with an external domain 606, e.g., the World Wide Web or the Internet or another operator managed network such as a WiMax or a cellular network.

In some embodiments, the API-GWF can host all Service Capability Exposure Framework (SCEF) functions such as providing API(s) with secured, authenticated and authorized access to the capabilities offered by the 3GPP MNO. It may also provide functions such as validating which SCS is authorized to trigger a 3GPP device/gateway, and charging for such services etc.

In addition, it may also be possible for the 3GPP MNO to identify and define to the API-GWF the set of service capabilities that the SCS can access from the underlying 3GPP MNO. The properties/parameters associated with such set of exposed service capabilities could also be identified to the API-GWF. TR22.853 (Study on Service Exposure and Enablement Support—SEES) identifies the potential set of service capabilities that the 3GPP MNOs could expose to the Application/SCS entities.

In some embodiments, the HSS (Home Subscriber Server) in the 3GPP network may operate to provide such functions. In some embodiments, the Txx interface 608 may be provided between the HSS and the API-GWF.

The 3GPP system has unique core assets, denoted as 3GPP service capabilities, such as Communications, Context, Subscription and Control that may be valuable to application providers. Communications refers to functions like voice calling, simple messaging service (SMS), multimedia messaging service (MMS). Subscription includes Subscription identity, feature sets, preferences, etc. Context covers real-time user information such as location, presence, profile, device capabilities and data connection type. Control addresses functions such as Quality of Service, policy and security.

3GPP Mobile Network Operators (MNO) can offer value added services by exposing these 3GPP service capabilities to external application providers, businesses and partners using web based application programming interfaces (APIs). In addition, 3GPP MNOs can combine other internal or external services with their network capabilities to provide richer, composite API services to their partners. This brings mobile network intelligence to applications, allowing new, profitable business relationships to be created between MNOs and a wide range of external providers of enterprise/business solutions and web-based services or content.

Such 3GPP services capabilities are already offered today to some extent to external application provider e.g. via OMA API(s). In one advantageous aspect, the techniques disclosed in the present document can be used to make available the 3GPP capabilities through a Service Capability Exposure framework that includes identification and definition of the Service Capabilities on the one hand and the exposure and discovery of the exposed capabilities on the other hand. The API(s) and the 3GPP system functionality can act together to expose 3GPP service capabilities.

Example Functionalities

The Service compatibility exposure framework may provide the capability for the identification and definition of 3GPP system service capabilities exposed to the external entities, e.g., application servers located in an external domain 606, and, for the external entities, the capability to discover such set of exposed service capabilities.

In some embodiments, service capability exposure framework may provide authorized and secure access to 3GPP system service capabilities and execution of the exposed services under operator control.

In some embodiments, the service capability exposure framework is extensible for exposing new services.

AESE Architecture

The exposure of services by the network creates a “toolbox” of capabilities that, with proper authorization, can be used, e.g., to retrieve information, to request specific services, to receive notifications, to request the setting of specific parameters, etc.

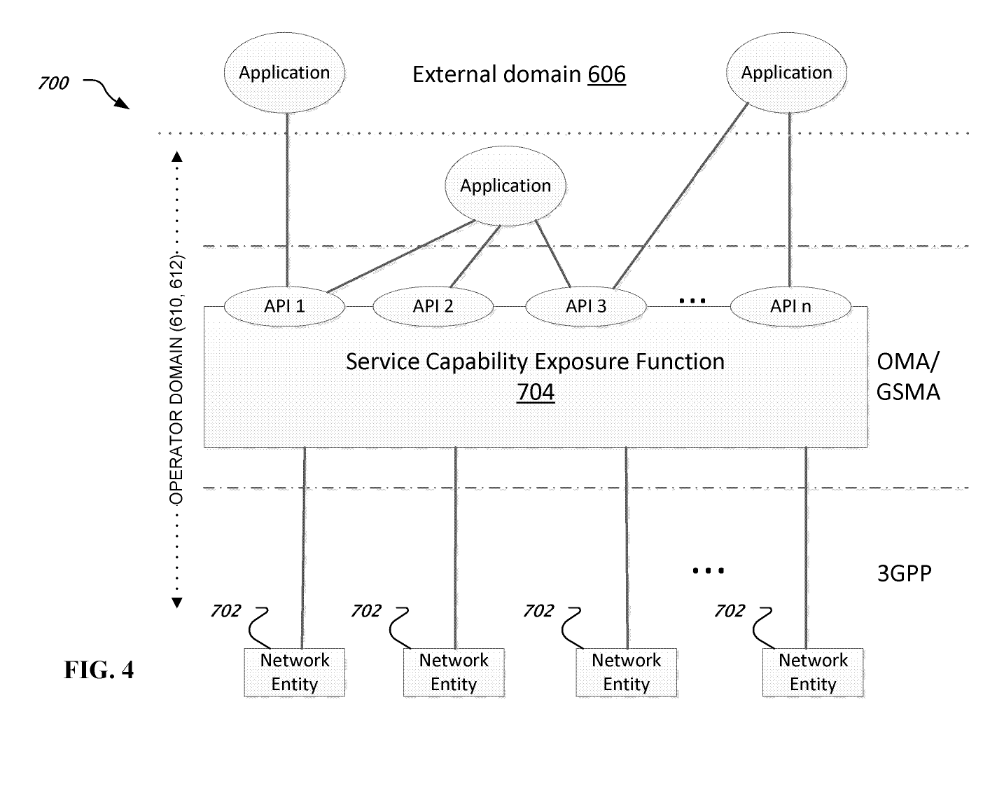

FIG. 4 illustrates an example 700 of interfaces for the SCEF 704 module.

The SCEF 704 provides a way to securely expose the services and capabilities provided by 3GPP network interfaces. In some embodiments, the SCEF 704 provides ways for identification, definition and discovery of the 3GPP service capabilities that have been exposed as well. The SCEF 704 provides access to network capabilities through homogenous network application programming interfaces (e.g. Network API) defined by OMA, GSMA, and possibly other standardization bodies. The SCEF 704 abstracts the services from the underlying 3GPP network interfaces and protocols.

In general, the 3GPP interfaces exposed by network entities 702 use protocols defined for those interfaces by 3GPP, and are not constrained to a single protocol.

Individual instances of SCEF may vary depending on what service capabilities are exposed and what API features are supported.

The functionality of the SCEF may include one or more of the following:

Authentication and Authorization—providing service information only to authorized and authenticated devices.

Identification of the API consumer—identifying the requester making a request over the API.

Profile management, ACL (access control list) management.

Identification of the exposed service capabilities:

Identification of 3GPP service capabilities exposed to the SCEF,

Definition of parameters/properties associated with such exposed service capabilities.

Discovery of the exposed service capabilities.

Capability for the Applications to be able to discover the service capabilities exposed by the underlying 3GPP network,

Capability for the Applications to be able to discover the parameters/properties (if any) associated with such exposed service capabilities.

Policy enforcement: The SCEF may implement several policies, e.g., as controlled by the network operator. Examples of policies include:

Infrastructural Policy: policies to protect platforms and the network. An example of which may be ensuring that a service node such in the network may not be overloaded.

Business Policy: policies related to the specific functionalities exposed. One example may be enforcing operator business policy regarding whether or not number portability is allowed for a particular subscriber, whether or not service routing is allowed, whether or not a subscriber consent is to be obtained before exposing a service to application servers, etc.

Application Layer Policy: policies that are primarily focused on message payload or throughput provided by an application. An example may be throttling traffic consumed or generated by an application on a service layer agreement basis.

In some embodiments, the SCEF includes Network APIs which are defined by OMA/GSMA for various services such as SMS, MMS, Location, Payment, etc.

Solution 2

This solution proposal modifies the Rel-12 MTC architecture for device triggering by introducing an API GateWay Function (API-GWF), which provides the horizontal functions of a standardised Service Capability Exposure Framework.

The API-GWF hosts all the Service Capability Exposure Framework functions, like providing the API(s) with secured, authenticated and authorized access to the capabilities offered by the 3GPP system, and functions like the identification, definition and discovery of such offered capabilities. In some embodiments, the SCEF 704 may also provide information used for charging for the API usage.

For the shown MTC-IWF it means: there is no need for performing charging or to verify, which SCS is permitted to trigger a device as that horizontal API framework functions are provided by the API-GWF. The Rel-12 MTC-IWF is thereby decomposed into specific device triggering capability functionality (provided by that MTC-IWF) and general Service Capability Exposure Framework functionality (provided by the API-GWF).

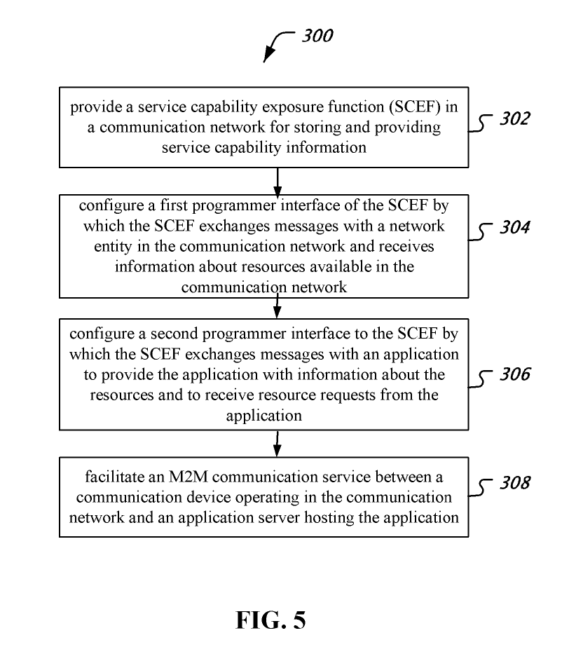

FIG. 5 shows an example flowchart of a method 300 for facilitating an M2M communication in a communication network. The method may be implemented by the SCEF 704 operating in an operator's managed communication network.

At 302, the method 300 includes providing a service capability exposure function (SCEF) in a communication network for storing and providing service capability information. The SCEF may be provided, or deployed, but the operator that manages the PLMN in which the SCEF is operated. The module may be incorporated into an existing network-side server platform or equipment, or may be deployed as a separate hardware platform.

At 304, the method 300 includes configuring a first programmer interface of the SCEF by which the SCEF exchanges messages with a network entity in the communication network and receives information about resources available in the communication network. The configuration of the first API may be performed by communicatively coupling the SCEF module 704 with an HSS in the operator network.

At 306, the method 300 includes configuring a second programmer interface to the SCEF by which the SCEF exchanges messages with an application to provide the application with information about the resources and to receive resource requests from the application. As depicted and discussed with respect to FIG. 3, the first programmers interface (e.g., Txx) and the second programmers interface may be operating in two different communication networks (e.g., wired Ethernet network, 3GPP wireless network, and so on).

At 308, the method 300 includes facilitating an M2M communication service between a communication device operating in the communication network and an application server hosting the application.

In some embodiments, the information about resources available in the communication network is different for different applications. For example, a network operator may implement certain business rules and allocate system resources such as bandwidth to different platforms (e.g., Android or iOS) or different physical layers (e.g., 3G or LTE).

In some embodiments, the SCEF may identify new resources available in the network to an application server, without the application server specifically asking for it. For example, the SCEF may announce an unrequested rate shaping or billing logging capability in the network to an application server.

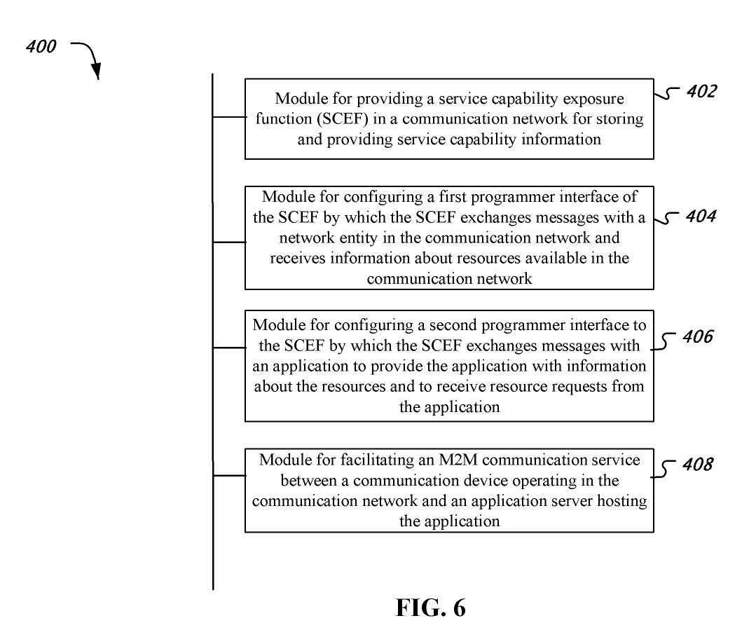

FIG. 6 shows an example apparatus 400 for facilitating M2M communication. The module 402 is for providing a service capability exposure function (SCEF) in a communication network for storing and providing service capability information. The module 404 is for configuring a first programmer interface of the SCEF by which the SCEF exchanges messages with a network entity in the communication network and receives information about resources available in the communication network. The module 406 is for configuring a second programmer interface to the SCEF by which the SCEF exchanges messages with an application to provide the application with information about the resources and to receive resource requests from the application. The module 408 is for facilitating an M2M communication service between a communication device operating in the communication network and an application server hosting the application.

In some embodiments, a communication apparatus includes a memory, a processor and a network interface. wherein the processor reads instructions from the memory and implements a method 500 for facilitating Machine to Machine (M2M) communication.

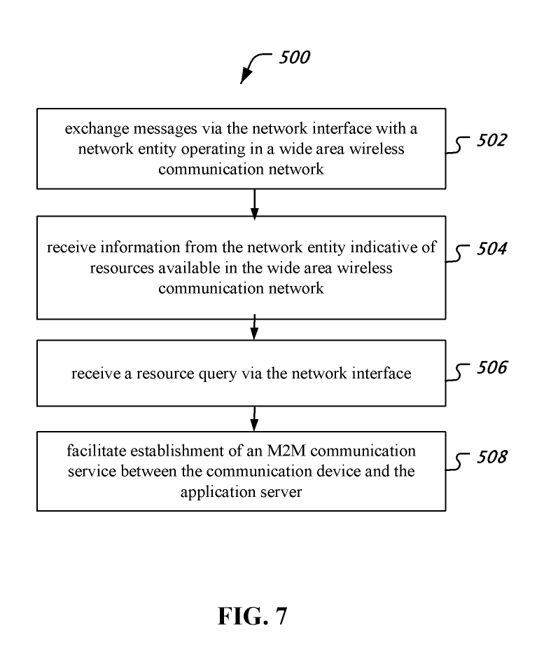

With reference to FIG. 7, the method 500 includes (502) exchanging messages via the network interface with a network entity operating in a wide area wireless communication network, (504) receiving information from the network entity indicative of resources available in the wide area wireless communication network, (506) receiving, from an M2M application server, a resource query via the network interface, the resource query requesting information about resource availability in the wide area wireless communication network for providing an M2M service to a communication device operating in the wide area communication network and (508) facilitating, by providing resource information to the application server, establishment of an M2M communication service between the communication device and the application server.

In some embodiments, the method 502 may be implemented by the SCEF module 704. It will be appreciated by one of skill in the art that the disclosed techniques facilitate exposing services in a M2M network at the SCEF, to enable M2M devices to be able to query and receive service information in the network, without having to undertake extensive service discovery procedures.

The disclosed and other embodiments and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for facilitating Machine-to-Machine (M2M) communication, the method comprising:
providing a service capability exposure function (SCEF) in a communication network for storing and providing service capability information for other devices in the communication network;
configuring a first programmer interface of the SCEF by which the SCEF exchanges messages with a network entity in the communication network and receives information about resources available in the communication network;
configuring a second programmer interface to the SCEF by which the SCEF exchanges messages with an application to provide the application with information about the resources and to receive resource requests from the application; and thereby facilitating an M2M communication service between a communication device operating in the communication network and an application server hosting the application.

2. The method of claim 1, wherein the first programmer interface and the second programmer interface operate on two different networks.

3. The method of claim 1, wherein the information about resources available in the communication network is different for different applications.

4. The method of claim 1, wherein the information about resources available in the communication network is controlled by business rules in the communication network.

5. The method of claim 1, wherein the information about the resources provided to the application identifies a resource not enquired by the application.

6. An apparatus, comprising:
a memory;
a processor; and
a network interface;
wherein the processor reads instructions from the memory and implements a method for facilitating Machine to Machine (M2M) communication, the instructions comprising:
code for exchanging messages via the network interface with a network entity operating in a wide area wireless communication network;
code for receiving information from the network entity indicative of resources available in the wide area wireless communication network;
code for receiving, from an M2M application server, a resource query via the network interface, the resource query requesting information about resource availability in the wide area wireless communication network for providing an M2M service to a communication device operating in the wide area communication network; and
code for facilitating, by providing resource information to the application server, establishment of an M2M communication service between the communication device and the application server.

7. The apparatus of claim 6, wherein the first programmer interface and the second programmer interface are configured to operate on two different networks.

8. The apparatus of claim 6, wherein the information about resources available in the communication network is different for different applications.

9. The apparatus of claim 6, wherein the information about resources available in the communication network is configured to be controlled by business rules in the communication network.

10. The apparatus of claim 6, wherein the information about the resources provided to the application is configured to identify a resource not enquired by the application.

11. A method of facilitating establishment of machine-to-machine (M2M) communication, comprising:
exchanging messages via a first network interface with a network entity operating in a wide area wireless communication network;
receiving information from the network entity indicative of resources available in the wide area wireless communication network;
receiving a resource query from an application server via a second network interface; and
facilitating establishment of an M2M communication service between the network entity and the application server.

12. The method of claim 11, further including authenticating and authorizing the network entity.

13. The method of claim 11, further including generating billing information for the network entity.

14. The method of claim 11, further including exposing services in the wide area wireless communication network to the application server.

15. (canceled)

16. A communication apparatus, comprising:
a memory configured to store data and instructions; and
a processor configured to read the instructions from the memory and to implement a method for facilitating Machine-to-Machine (M2M) communication, the instructions comprising:
code for providing a service capability exposure function (SCEF) in a communication network for storing and providing service capability information for other devices in the communication network;
code for configuring a first programmer interface of the SCEF by which the SCEF exchanges messages with a network entity in the communication network and receives information about resources available in the communication network;
code for configuring a second programmer interface to the SCEF by which the SCEF exchanges messages with an application to provide the application with information about the resources and to receive resource requests from the application; and thereby
code for facilitating an M2M communication service between a communication device operating in the communication network and an application server hosting the application.

17. The communication apparatus of claim 16, wherein the first programmer interface and the second programmer interface are configured to operate on two different networks.

18. The communication apparatus of claim 16, wherein the information about resources available in the communication network is different for different applications.

19. The communication apparatus of claim 16, wherein the information about resources available in the communication network is configured to be controlled by business rules in the communication network.

20. The method of claim 16, wherein the information about the resources provided to the application is configured to identify a resource not enquired by the application.

21. A communication apparatus, comprising:
a memory configured to store data and instruction; and
a processor configured to read the instructions from memory and to implement a method for facilitating establishment of machine-to-machine (M2M) communication, the instructions comprising:
code for exchanging messages via a first network interface with a network entity operating in a wide area wireless communication network;
code for receiving information from the network entity indicative of resources available in the wide area wireless communication network;
code for receiving a resource query from an application server via a second network interface; and
code for facilitating establishment of an M2M communication service between the network entity and the application server.

22. The communication apparatus of claim 21, further including code for authenticating and authorizing the network entity.

23. The communication apparatus of claim 21, further including code for generating billing information for the network entity.

24. The communication apparatus of claim 21, further including code for exposing services in the wide area wireless communication network to the application server.
